(19) United States
(12) Patent Application Publication
(10) Pub. No.: US 2004/0008837 A1
(43) Pub. Date: Jan. 15, 2004

(54) Combining multimedia services with traditional telephony services in a public branch exchange

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/193,885

(22) Filed: Jul. 12, 2002

(51) Int. Cl. H04M 3/00; H04M 5/00; H04M 7/00; H04L 12/66

(52) U.S. Cl. 379/265.09; 379/219; 370/352

(57) ABSTRACT

The present invention provides a combined user agent (CUA) to represent a telephony device supported by a private branch exchange (PBX), which is connected to a public domain telephony switch, and a packet-based media device as an integrated group to other network entities. The CUA is configured to facilitate the necessary call signaling to establish and control a voice call via the PBX and an associated telephony switch, as well as the session control signaling necessary to establish and control a media session with the media device. Accordingly, the telephony device and media device appear to the network devices as a single device having voice and media capabilities, wherein the voice capabilities are controlled in part by the telephony switch and PBX.

### FIELD OF THE INVENTION

The present invention relates to facilitating multimedia services, and in particular, associating multimedia services with traditional telephony in a public branch exchange (PBX) in an efficient manner.

### BACKGROUND OF THE INVENTION

Traditional telephony services provided by digital switches, such as digital multiplexing switches, have reached their functional limits with existing user interfaces, which essentially are telephone sets having limited displays and simple keypads. Further, the telephone sets have limited bandwidth. Over newer packet networks, multimedia services are flourishing and are capable of exploiting the capabilities of advanced user terminals, desktop computers, and network appliances.

Currently, the vast majority of voice telephony is provided, at least in part, by traditional circuit-switched networks. Given the extensive infrastructure, reliability, and quality of service, these traditional telephony systems are likely to remain a significant part of communications for the foreseeable future. Unfortunately, there has been difficulty integrating voice sessions over the traditional telephony network with multimedia sessions over packet networks. Users prefer the traditional telephony network for voice, yet the voice network is unacceptable for facilitating advanced multimedia services, such as screen sharing, video conferencing, and the like.

Further, a large number of enterprises use public branch exchanges (PBXs) to provide most of the telephony services to the employees of that enterprise as opposed to relying on the public network telephony switch. In a typical situation, the PBX is involved in all calls within the enterprise while the public network telephony switch is used only for calls in and out of the enterprise. These enterprise users are also typically those most likely to want to combine traditional telephony services with multimedia services to improve employee productivity. As such, many functions or features provided by a traditional switch may be unavailable to enterprise users serviced by a PBX. Accordingly, those users most likely to need to combine multimedia and traditional telephony services are even further removed from such capability. Given the unique strengths of the respective communication systems, there is a need for an efficient and economical way to facilitate interworking between the packet- and circuit-switched networks. There is a further need to facilitate such interworking in enterprise networks supported by a PBX without requiring significant changes to the traditional telephony or packet-switched infrastructures and communication protocols.

### SUMMARY OF THE INVENTION

The present invention provides a combined user agent (CUA) to represent a telephone supported by a private branch exchange (PBX), which is connected to a public domain telephony switch, and a packet-based media device as an integrated group to other network entities. The CUA is configured to facilitate the necessary call signaling to establish and control a voice call via the PBX and an associated telephony switch, as well as the session control signaling necessary to establish and control a media session with the media device. Accordingly, the telephone and media device appear to the network devices as a single device having voice and media capabilities, wherein the voice capabilities are controlled in part by the telephony switch and PBX.

Although the telephony switch may use circuit-switched communications, the telephone may be a circuit-switched telephone supported by the switch or may be a packet-based telephone, which is supported by a gateway supported by the telephony switch. Further, the call signaling may take any form acceptable by the telephony switch to facilitate call processing and control. For example, the call signaling may conform to an intelligent network protocol and take place in part over an intelligent network primarily dedicated for call signaling.

In one embodiment, the session initiation protocol (SIP) is used to facilitate communications between the CUA and other SIP devices as well as the media devices represented by the CUA. Preferably, the voice call and media session are associated with one another using the CUA, and information about or related to the voice call and media session may be shared with applications participating in the voice call or media session. The applications may include video conferencing, audio streaming, video streaming, information streaming, voicemail, email, gaming, advertising, screen sharing, instant messaging, and the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment according to a first embodiment of the present invention.

FIG. 2 is a communication environment according to a second embodiment of the present invention.

FIG. 3 is a communication environment according to a third embodiment of the present invention.

FIG. 4 is a block representation of a combined user agent according to one embodiment of the present invention.

FIGS. 5A, 5B, and 5C are a communication flow diagram outlining an exemplary technique for associating a voice sharing and a screen sharing multimedia session in a communication environment as illustrated in FIG. 3.

FIG. 6 is a communication environment according to a fourth embodiment of the present invention.

FIGS. 7A, 7B, and 7C are a communication flow diagram outlining an exemplary technique for associating a voice sharing and a screen sharing multimedia session in a communication environment as illustrated in FIG. 6.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention facilitates efficient unification of parallel voice and multimedia sessions, wherein the voice session takes place in part over a traditional circuit-switched telephony network. The voice session may be facilitated via a public branch exchange (PBX) serviced by a traditional telephony switch. A call signaling agent is created to control packet-based multimedia sessions, as well as to control call signaling at a traditional telephony switch or PBX, for a telephone, and an associated multimedia device, such as a computer. The multi-functional call signaling agent, typically referred to as a combined user agent (CUA), can effectively establish multimedia sessions with the multimedia device and voice calls with the telephone.

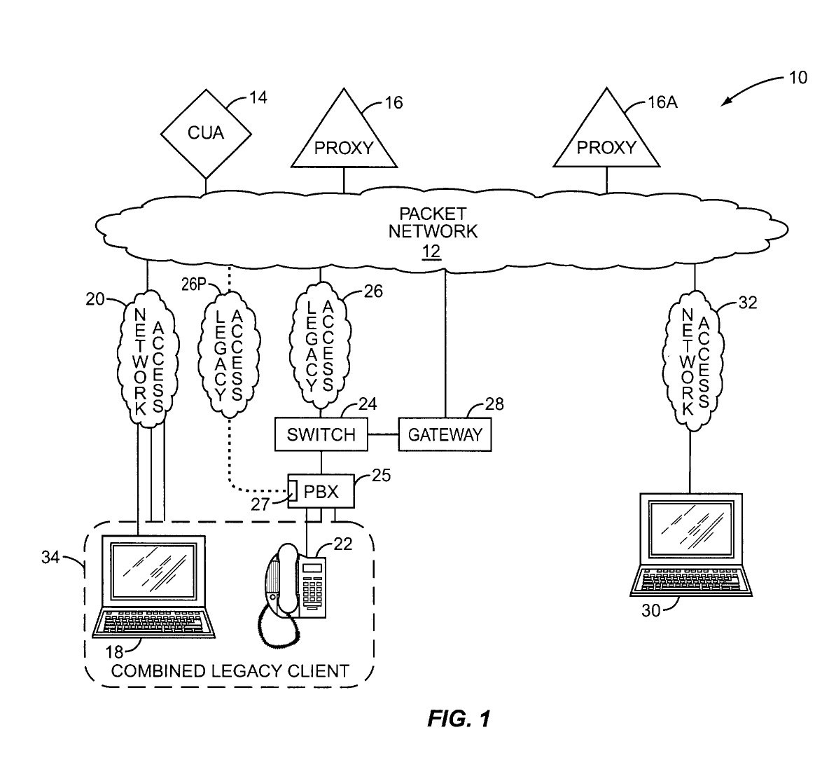

With reference to FIG. 1, a communication environment 10 according to one embodiment is illustrated. The communication environment 10 may include a packet network 12 including a CUA 14 and a supporting proxy 16. The CUA 14 acts as a virtual agent for a computing device, such as a computer 18, which is capable of supporting multimedia sessions. The computer 18 may connect to the packet network 12 via a network access 20, which may include a local area network (LAN), frame relay, digital subscriber line (DSL), cable, or the like.

The CUA 14 also acts as an agent for a traditional telephony device, such as a telephone 22, which is supported by a PBX 25 such as a Nortel Networks Meridian 1, via a telephony switch 24 such as Nortel Networks DMS-100, that is capable of providing telephony services between the telephone 22 and other telephony devices. To allow the CUA 14 to interact with and control the telephony switch 24, legacy access 26 is provided between the packet network 12 and the telephony switch 24. The legacy access 26 may be provided by existing intelligent networks (IN) interfaces, including the advanced intelligent network (AIN), a SIP-T capable interface, and a TAPI interface, that provides access to telephony switches 24 to facilitate call signaling. The CUA 14 is configured to establish multimedia sessions over network access 20 with the computer 18 as well as provide call signaling for the telephone 22 through the telephony switch 24 via the legacy access 26. A computer telephony interface (CTI) 27 or other interface may be provided to facilitate call signaling between the PBX 25 and the CUA 14 via legacy access 26P. Such interaction and use of the CTI 27 is discussed later in the description. The CUA 14 has therefore two interfaces it can use to facilitate call signaling, one to the telephony switch 24 and one to the PBX 25. Each interface can be used in isolation or jointly to provide certain service types, providing maximum flexibility. For example, the interface to the telephony switch 24 can be used alone to provide multimedia services for calls between the enterprise users and the PSTN users, and do this without modifying the serving PBX 25. The interface to the PBX 25 can be used alone to handle all calls within the enterprise as well as for calls with PSTN users, without requiring an interface to the telephony switch 24. Finally, both interfaces can be used jointly, providing various points during call progress to trigger additional services.

Although the concepts of the present invention are applicable to various communication environments and related protocols, the present invention is preferably implemented using the session initiation protocol, which is commonly referred to as SIP. The specification for SIP is provided in the Internet Engineering Task Force's Request for Comments (RFC) 2543: Session Initiation Protocol Internet Draft, which is incorporated herein by reference in its entirety. In general, SIP is used to establish media sessions between any number of endpoints. Typically, these endpoints may support any number or combination of data, audio, and voice media sessions, depending on the configuration of the device. A SIP endpoint is capable of running an application, typically referred to as a user agent (UA), which is capable of facilitating media sessions using SIP. In certain embodiments, user agents may register their ability to establish sessions with a SIP proxy by sending “REGISTER” messages to the SIP proxy. The REGISTER message informs the SIP proxy of the SIP universal resource locator (URL) that identifies the user agent to the SIP network. The REGISTER message also contains information about how to reach specific user agents over the SIP network, typically by providing the Internet Protocol (IP) address and port that the user agent will use for SIP sessions. When a user agent wants to establish a session with another user agent, the user agent initiating the session may send an INVITE message to the SIP proxy and specify the target user agent in the TO header of the INVITE message. Identification of the user agent takes the form of a SIP URL. The SIP proxy will use the SIP URL in the TO header of the message to determine if the targeted user agent is registered with the SIP proxy. Generally the user name is unique within the name space of the specified domain.

If the targeted user agent has registered with the SIP proxy, the SIP proxy will forward the INVITE message directly to the targeted user agent. The targeted user agent will respond with a 200 OK message, and a session between the respective user agents will be established as per the message exchange required in the SIP specification. Media capabilities are passed between the two user agents of the respective endpoints as parameters embedded within the session setup messages, such as the INVITE, 200 OK, and acknowledgement (ACK) messages. Media capabilities may be exchanged in other messages, such as the SIP “INFO” message. Media capabilities are typically described using the session description protocol (SDP). Once respective endpoints are in an active session with each other and have determined each other's capabilities, the specified media content may be exchanged during an appropriate media session.

According to the Internet Engineering Task Force's RFC 2543, a user agent is an application that contains both a user agent client and a user agent server. A user agent client generally refers to a client application that initiates SIP requests, wherein a user agent server is an application that contacts the user when a SIP request is received, and returns a response on behalf of the user. Typically, the response accepts, rejects, or redirects the received request.

The present invention provides for a CUA 14, which is an application, program, or function that acts on behalf of a multimedia client, provided by the computer 18 or other multi-media device, and a telephone 22. The computer 18 may have a SIP user agent, which is represented by the CUA 14. In essence, the CUA 14 will function to control call signaling to effect voice sessions between the telephone 22 and other devices via the telephony switch 24 and PBX 25, and other multimedia sessions via the computer 18. Notably, the CUA 14 can effectively facilitate the integration and association of voice and other multimedia sessions provided by both devices. To devices needing to establish sessions with either the computer 18 or the telephone 22 in a SIP environment, the CUA 14 represents both devices as a single device having voice and other multimedia capabilities. The other devices need not know that the telephone 22 resides on a circuit-switched network.

In one embodiment, the CUA 14 will cooperate with a proxy 16, which is configured as a SIP proxy, in traditional fashion to establish multimedia sessions involving the computer 18. The sessions will be supported across the network access 20 in the packet network 12. With respect to voice communications via the telephone 22, the voice path may take various routes, remaining entirely within the public switched telephone network (PSTN), or venturing into the packet network 12 to communicate with a packet-switched telephony device or simply to bridge to another circuit-switched network.

The communication environment 10 illustrated in FIG. 1 illustrates voice communications between the telephone 22 and a multimedia-capable packet-switched device 30, such as a SIP terminal. The multimedia-capable packet-switched device 30 is connected to the packet network 12 via a network access 32 to support packet-switched communications. The multimedia-capable packet-switched device 30 may be supported by a separate proxy 16A or may be served by the same proxy 16 as CUA 14, depending on the network requirements. Since the telephone 22, PBX 25, and telephony switch 24 facilitate circuit-switched communications, a gateway (GW) 28 is either integrated with the telephony switch 24 or provided as a separate device (as shown) to convert circuit-switched communications to packet-switched communications capable of being transported over the packet network 12 to the desired multimedia-capable packet-switched device 30. The connection between the telephony switch 24 and the gateway 28 may be any traditional telephony line or trunk. The gateway 28 appears to the telephony switch 24 as another switching device supporting a variety of telephone numbers, which are associated with the packet-switched devices 30. Typically, the time-division multiplexed (TDM) circuit-switched communications are converted into packets to facilitate voice communications over the Internet Protocol (Vol P). Importantly, although the voice session spans the circuit-switched and packet-switched networks, the CUA 14 represents the telephone 22 to the devices with which it communicates. In essence, the telephone 22 and the computer 18 form a combined legacy client 34, which is represented by the CUA 14.

Many enterprises rely on the PBX 25 to provide voice services to its employees. Calls internal to the enterprise served by the PBX 25 do not exit the PBX 25, and thus are not visible to the switch 24. In a typical configuration, each telephone 22 served by the PBX 25 may have a corresponding PSTN directory number, where users external to the enterprise can dial the PSTN directory number directly to reach the enterprise user without having to go through an operator. To achieve such functionality, the PBX 25 employs Direct Inward Dialing (DID)/Direct Outward Dialing (DOD) trunk types, which connect the PBX 25 to the switch 24. The switch 24 is provisioned with a list or range of directory numbers associated with the PBX 25 and will route calls for these directory numbers on the DID/DOD trunk(s) connecting the switch 24 and PBX 25. The DID/DOD trunks are typically sized to match the required ingress and egress calls coming into and leaving the enterprise. A signaling channel is used to pass information from the switch 24 to the PBX 25 regarding which channel corresponds to what enterprise user for every call. This arrangement allows a large number of enterprise users to share a smaller trunk while preserving direct dialing.

When a call comes in for an enterprise user 22 from a multimedia-capable packet-switched device 30, the voice call can be presented via the gateway 28 to the switch 24 using, for example, a primary rate interface (PRI). The switch 24 performs a standard translation and identifies the directory number as belonging to one of the enterprise users served by the PBX 25 via the DID/DOD trunk. The switch 24 is provisioned to recognize that the directory number for the enterprise user is associated with the CUA 14, which enables a number of multimedia services. The incoming call to the enterprise user triggers the switch 24 to send a message to the CUA 14 using a control protocol, such as AIN, INAP, SIP-T, or TAPI. The CUA 14 uses the called party information, such as the directory number for the enterprise user, to identify a profile and user information associated with the enterprise user. The profile and user information may identify the addresses and capabilities of the multimedia devices, such as the computer 18. Those skilled in the art will recognize that the multimedia devices may include personal digital assistants, Internet appliances, televisions, and the like.

The CUA 14 in conjunction with the proxy 16 can perform incoming call treatment. The CUA 14 can provide call filtering based on incoming directory numbers or names, time of day, day of the week, and the like and let the call proceed to the enterprise user. The CUA 14 can also re-route the incoming call to other extensions, a voice mail system, and interactive voice response system (IVR), or the like by sending back via control protocol a new destination for the incoming call to the switch 24, which will route the incoming call to the directory number or location provided by the CUA 14.

In parallel, the CUA 14 can forward the incoming call information to the computer 18 using a second control protocol via the packet network 12 to inform the enterprise user of the call. Providing the call information to the computer 18 allows the enterprise user to control the incoming call via the computer 18 as well as the telephone 22. Such control of the call via the computer 18 or other multimedia device can be used to allow the enterprise user to screen the call in real time and push the call to voicemail by clicking a button on a pop-window associated with the incoming call.

The CUA 14 may also pass the caller information to the proxy 16, which can log the call. The resulting call log may be accessed by the computer 18 for information on the caller or call, as well as initiate a call back to the caller. The call log information may also be stored on the computer 18. By sending a message to the CUA 14, the computer 18 can trigger outbound calls from an enterprise user. The CUA 14 controls the switch 24 to connect to the telephone 22 of the enterprise user, and when the enterprise user picks up the telephone 22, initiates an outbound call to a user outside of the enterprise.

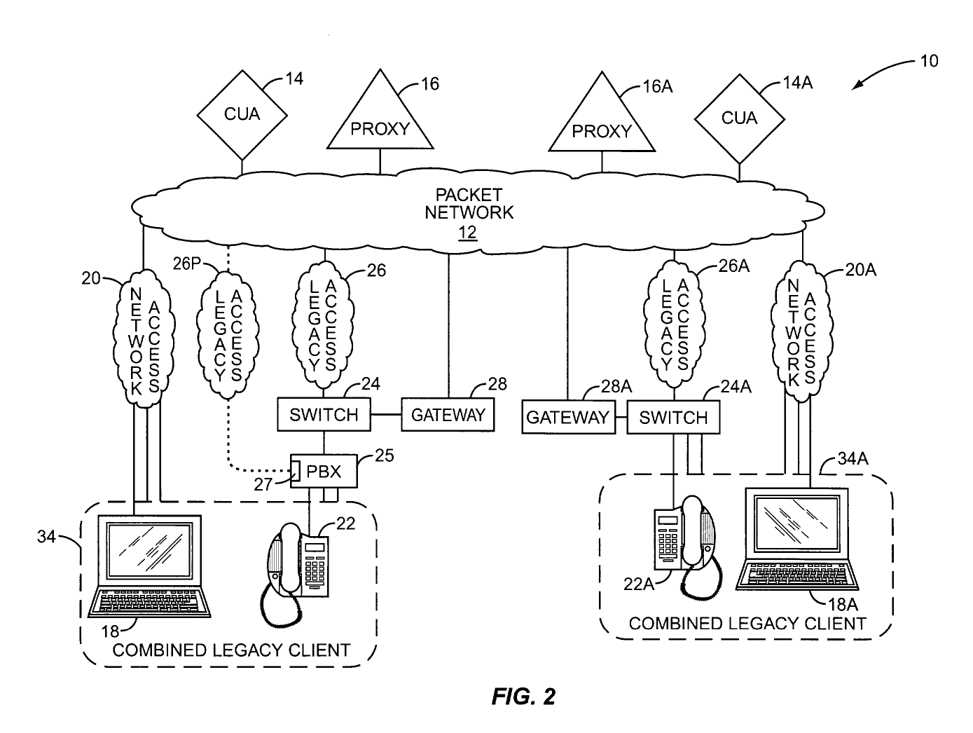

With reference to FIG. 2, another CUA 14A is provided to support a computer 18A via network access 20A and a circuit-switched telephone 22A, which is also supported by telephony switch 24A. CUA 14A may be supported by a separate proxy 16A or served by the same proxy 16 as CUA 14, depending on the network requirements. CUA 14A provides call signaling to the telephony switch 24A via legacy access 26A in a similar manner to that described above. Further, telephony switch 24A is associated with a gateway 28A to convert circuit-switched communications into packet-switched communications for transport over the packet network 12. The communication environment 10 in FIG. 2 illustrates the circuit-switched communications between telephone 22 and telephone 22A during a voice session being routed over the packet network 12 between gateways 28 and 28A. Multimedia sessions other than voice between computers 18 and 18A may be established in traditional fashion over the packet network 12. Again, CUA 14 represents combined legacy client 34 containing computer 18 and telephone 22, whereas CUA 14A supports combined legacy client 34A, which is made up of computer 18A and telephone 22A. In this embodiment, the proxy 16 also supports CUA 14A. It should be noted that CUA 14 is a logical entity representing one user. When multiple users need to be supported, then multiple CUAs, 14 are used, although they might all be running on the same computing server.

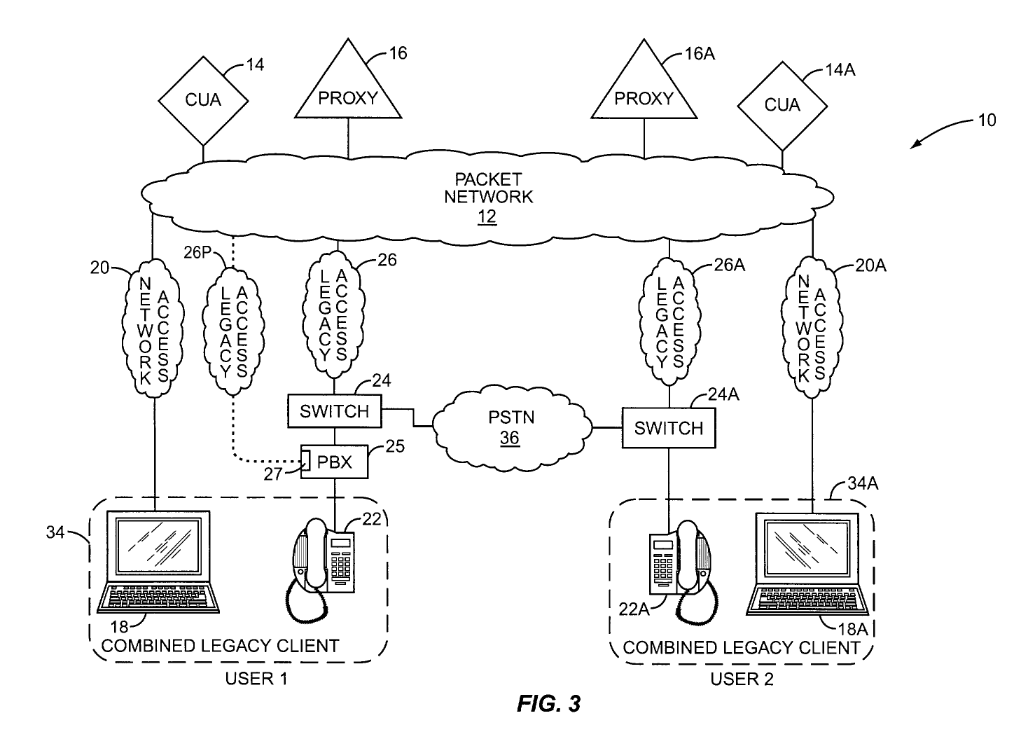

With reference to FIG. 3, the communications between telephone 22 and telephone 22A during a voice session may be supported entirely within the PSTN 36. CUAs 14 and 14A may provide call signaling not only to respective telephony switches 24 and 24A via legacy access 26 and to the PBX 25 via CTI 27, but to other network elements within the PSTN 36. In short, CUAs 14 and 14A are configured to provide the necessary call signaling to establish voice sessions that are supported at least partially over the circuit-switched network of the PSTN 36, as well as multimedia sessions with computer 18 over the packet network 12. Notably, user 2 may only have telephone 22A and CUA 14A available, and no computer 18A. In that scenario, user 1 can still use some of the functionality and services possible with this invention, such as call screening, call logging, and click-to-call, but may not initiate other media sessions with user 2 as no multimedia capabilities are available.

When both the enterprise user (user 1) and another party (user 2) are associated with combined legacy clients 34 and 34A, CUA 14 and the proxy 16 can support the setup of additional multimedia sessions. Using incoming call information previously received, CUA 14 and proxy 16 associated with user 1 can perform a search to identify if the caller has multimedia capabilities. The search can take multiple forms. One method includes querying well known proxies responsible for specific blocks of directory numbers, such as that provided for an area code. A hierarchy of proxies can also be used to sub-divide the directory numbers. Eventually, the search will either fail or identify proxy 16A and CUA 14A corresponding to the multimedia capabilities associated with user 2. When both user 1 and user 2 have multimedia capabilities, either user can set up parallel multimedia sessions with the other. The multimedia capabilities may include video, instant messaging, file transfer, email, and screen sharing, among other capabilities.

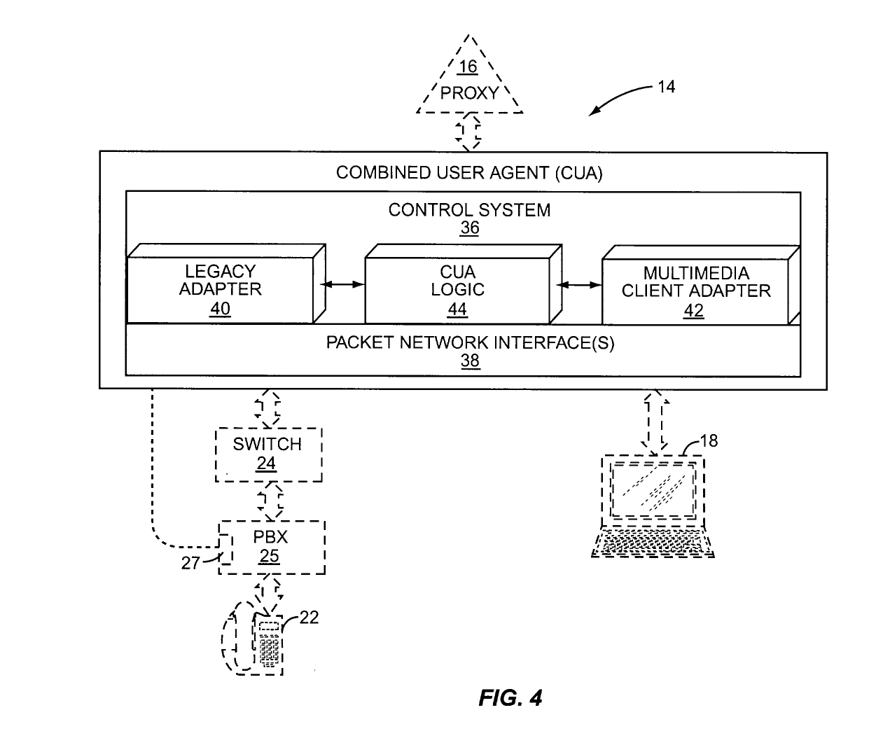

As illustrated in FIG. 4, the combined user agent 14 is preferably implemented in a control system 36 associated with one or more packet network interfaces 38 for communicating over the packet network 12. The control system 36 will support software applications providing a legacy adapter 40, a multimedia client adapter 42, and the basic CUA logic 44. The legacy adapter 40 will provide the necessary protocol adaptation and call signaling control necessary to control either the telephony switch 24, the PBX 25, or both using existing telephony control protocols. The multimedia client adapter 42 is used to support sessions with the associated computer 18 or like multimedia device. The multimedia client adapter 42 may provide protocol adaptation as necessary to establish the media sessions using protocols such as SIP when the computer 18 emulates a SIP client, or other control protocol (http, XML, etc.) for other types of clients. The CUA logic 44 will also cooperate with the legacy adapter 40 to provide the necessary call signaling for the telephony switch 24 to control voice communications with the telephone 22. Accordingly, the CUA logic 44 cooperates with the legacy adapter 40 and the multimedia client adapter 42 to provide an interface to the computer 18 as well as an interface to the telephony switch 24, and an interface for communications with other devices, such as the proxy 16.

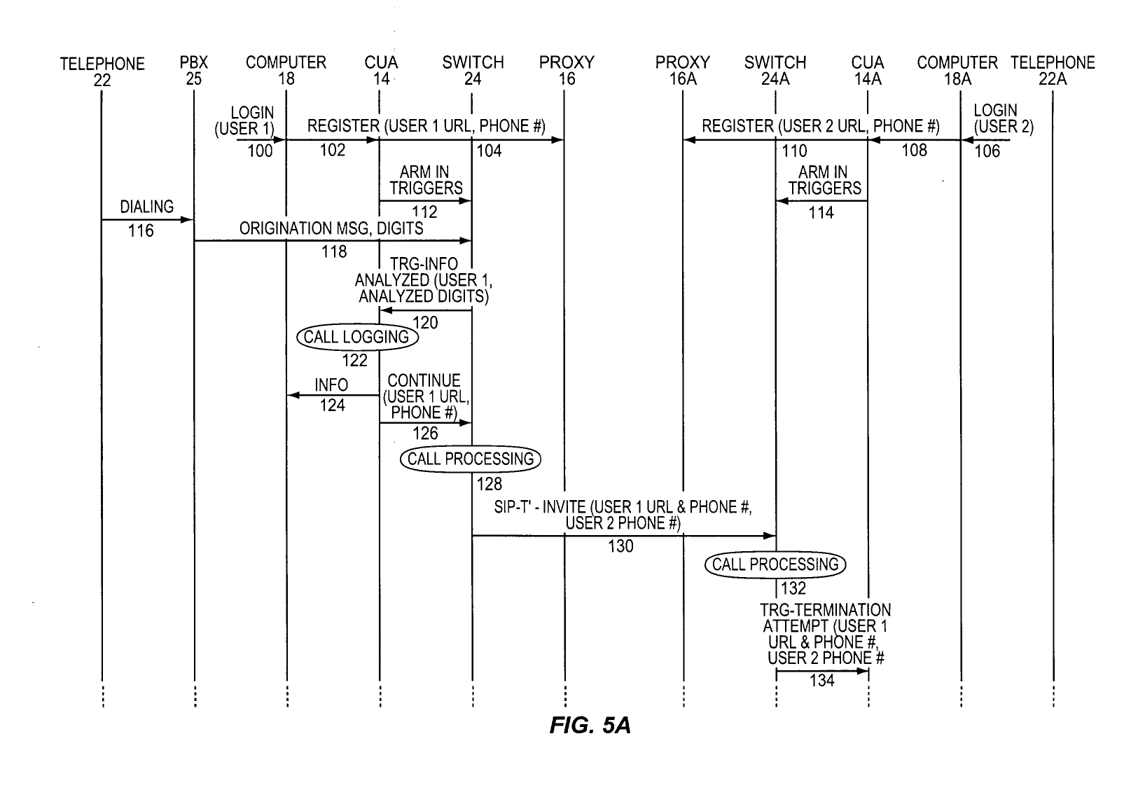

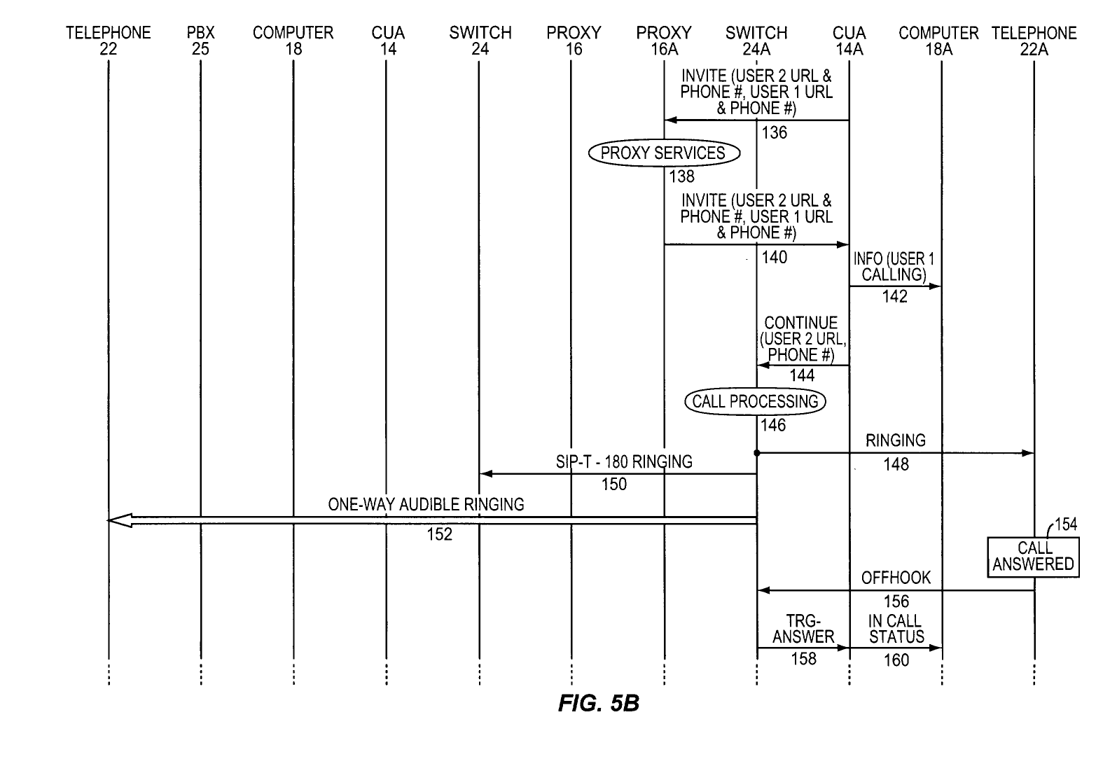

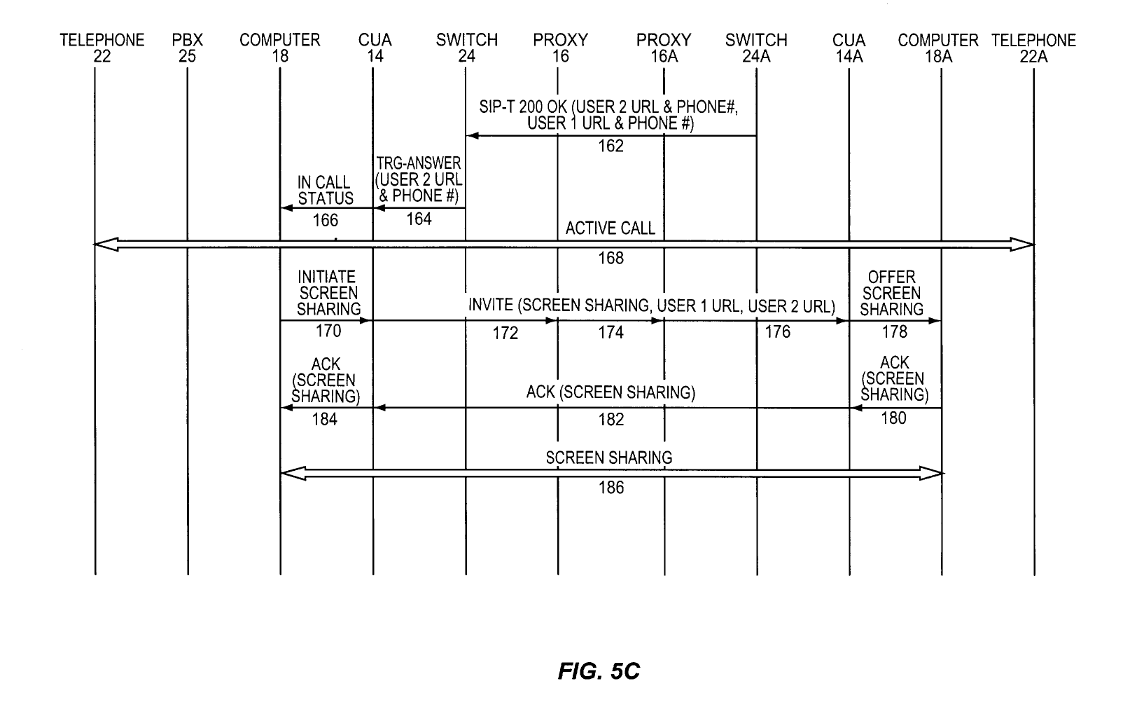

Turning now to FIGS. 5A-5C, an exemplary communication flow is shown for establishing a voice session and a screen sharing session between telephones 22 and 22A and computers 18 and 18A, respectively, in the communication environment 10 of FIG. 3. In a SIP environment, user 1 and user 2 will log into their respective computers 18 and 18A, which will register with their respective proxies 16 and 16A. Accordingly, user 1 will log into computer 18 (step 100), which will send a REGISTER message to CUA 14 with the URL for computer 18 and the telephone number for associated telephone 22 (step 102). CUA 14 will provide this information to the supporting proxy 16 in a REGISTER message (step 104). Likewise, user 2 will log into computer 18A (step 106), which will provide the URL for computer 18A and the telephone number for associated telephone 22A to CUA 14A (step 108), which will send another REGISTER request to associated proxy 16A (step 110).

In this implementation, where an IN interface is used to control the telephony switch 24, CUA 14 will then arm the intelligent network triggers by sending an appropriate message to switch 24 (step 112). CUA 14A will also arm the intelligent network triggers of telephony switch 24A (step 114). At this point, combined legacy clients 34 and 34A are properly registered and ready for initiating voice and other multimedia sessions.

Assume the session is initiated by user 1 dialing the telephone number of telephone 22A at telephone 22 (step 116). Accordingly, the PBX 25 will alert switch 24 of a call origination and will report the digits dialed (step 118). In this embodiment, messages between telephone 22, the PBX 25, telephony switches 24, 24A and telephone 22A are transported in traditional PSTN fashion. Telephony switch 24 will start processing the call as usual and will reach a point where it will encounter the IN trigger, set in step 112. Switch 24 will respond by sending an information-analyzed message to CUA 14 indicating that user 1 is dialing the number of telephone 22A (step 120). CUA 14 will log the call (step 122) and send an INFO message to computer 18 indicating that the call is proceeding (step 124). Computer 18 may use this information to retrieve relevant information like appointments, emails, and documents, which may be associated with user 2, who is associated with the telephone number of telephone 22A. CUA 14 will next send a CONTINUE message to switch 24 providing the URL and phone number for user 1 (step 126). Upon receiving the CONTINUE message, telephony switch 24 will continue call processing (step 128) until it reaches the point where it determines that the call needs to proceed via switch 24A. To do so, switch 24 will send a SIP trunking (SIP-T′) INVITE message to telephony switch 24A via the packet network 12 (step 130). The INVITE message will include the URL and telephone number for user 1 as well as the dialed number corresponding to telephone 22A (user 2). In return, telephony switch 24A will provide call processing (step 132) and eventually encounter the intelligent network trigger that was armed in step 114. This will cause telephony switch 24A to send a message to CUA 14A indicating an attempt to terminate a call for telephone 22A (step 134). The message received by CUA 14A will include the URL and telephone number for user 1 and the telephone number for telephone 22A.

CUA 14A will perform a lookup using the telephone number for telephone 22A, add the corresponding URL for computer 18A and forward an INVITE message including the URLs and telephone numbers for both user 1 and user 2 to proxy 16A (step 136). Proxy 16A will provide any necessary services (step 138), such as call screening, and, assuming that the call can proceed to telephone 22A, will respond with an INVITE message back to CUA 14A (step 140), which will trigger CUA 14A to send an INFO message indicating that user 1 is calling user 2 on telephone 22A to computer 18A for reference (step 142). Further, CUA 14A will send a CONTINUE message identifying the URL and telephone number for user 2 to telephony switch 24A (step 144). Telephony switch 24A will provide further call processing (step 146) and apply ringing to telephone 22A of user 2 (step 148). Telephony switch 24A will also send a SIP-T 180 RINGING message to telephony switch 24 to indicate that telephone 22A is being rung (step 150). The PBX 25 and telephony switch 24 will enable the voice path toward telephone 22 of user 1, which will result in a one-way voice path, with the audible ringing sent by switch 24A to be heard at telephone 22 (step 152).

At some point, user 2 will answer the call (step 154), which will prompt telephone 22A to indicate an OFFHOOK condition, which is detected by telephony switch 24A (step 156). In response, telephony switch 24A will perform additional call processing and will encounter another intelligent network trigger armed in step 114. This trigger will cause telephony switch 24A to send an ANSWER message to CUA 14A (step 158), which will send a message to computer 18A that a call is in progress (step 160). Further, telephony switch 24A will send a SIP-T 200 OK message including the URLs and telephone numbers for both users 1 and 2 to telephony switch 24 (step 162), which will enable a two-way voice path. Telephony switch 24 will also perform additional call processing and will encounter another intelligent network trigger armed in step 112. Telephony switch 24 will send an ANSWER message including the URL and telephone number of user 2 to CUA 14 (step 164), which will send a message to computer 18 that a call is in progress (step 166). At this point, a call is established between telephone 22 and telephone 22A (step 168).

Once the voice session is established between telephones 22 and 22A, a screen sharing application is initiated by user 1 at computer 18. Accordingly, computer 18 will send a message to CUA 14 indicating that it wants to initiate screen sharing (step 170). CUA 14 will send a SIP INVITE message to the supporting proxy 16 indicating that a screen sharing session is desired between computers 18 and 18A having the URLs associated with both users (step 172). Proxy 16 will forward the INVITE message to SIP proxy 16A (step 174), which will further forward the INVITE message to CUA 14A (step 176). CUA 14A will send a message offering screen sharing to computer 18A (step 178). Computer 18A, assuming that screen sharing is accepted, will send an acknowledgement (ACK) of the screen sharing to CUA 14A (step 180), which will forward a similar ACK message to CUA 14 (step 182), which will further forward the ACK message to computer 18 (step 184). Upon completion of the ACK messages, a screen sharing session is established between computer 18 and computer 18A (step 186).

As seen from the above, the CUA 14 operates on behalf of the supported telephone 22 and computer 18 to facilitate media sessions as a packet-switched entity. For voice sessions, the CUA 14 effectively controls call signaling for the supporting the PBX 25 and the telephony switch 24 to facilitate voice sessions without knowledge by other network devices.

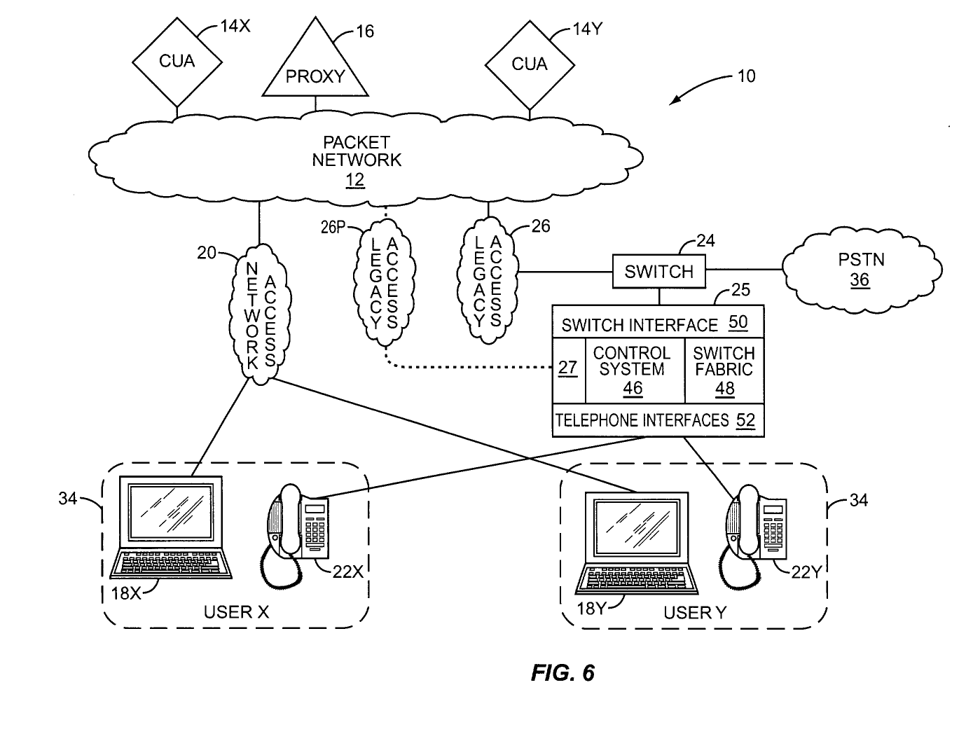

Turning now to FIG. 6, as indicated above, the telephony switch 24 plays a significant role in monitoring incoming or outgoing calls and associating multimedia sessions with those calls by interacting with the CUA 14. Since calls within an enterprise system are processed completely by the PBX 25, the PBX 25 is modified to interact with the CUA 14 in a fashion similar to the telephony switch 24. Since most PBXs support some form of CTI, one embodiment of the present invention uses the CTI 27 to send CUAs 14X and 14Y associated with user X and user Y additional information about the calls local to the PBX 25, as shown in FIG. 6. When user X calls user Y using an enterprise dialing plan, the origination attempt to user Y triggers a CTI message to CUA 14X indicating a call is being made between telephones 22X and 22Y.

Notably, the PBX 25 will typically include a control system 46 associated with the CTI 27, a switch interface 50 supporting trunks connected to the telephony switch 24, telephone interfaces 52 supporting lines or trunks directly or indirectly connected to telephones 22X and 22Y, and a switching fabric 48. The switching fabric 48 operates under the control of the control system 46 to establish circuit-switched connections between supported telephones 22X and 22Y as well as between the supported telephones 22X, 22Y and a telephone outside of the enterprise network. With this configuration, CUA 14 has access to all the internal calls to the enterprise and supports the same services as it would for the calls to and from the PSTN.

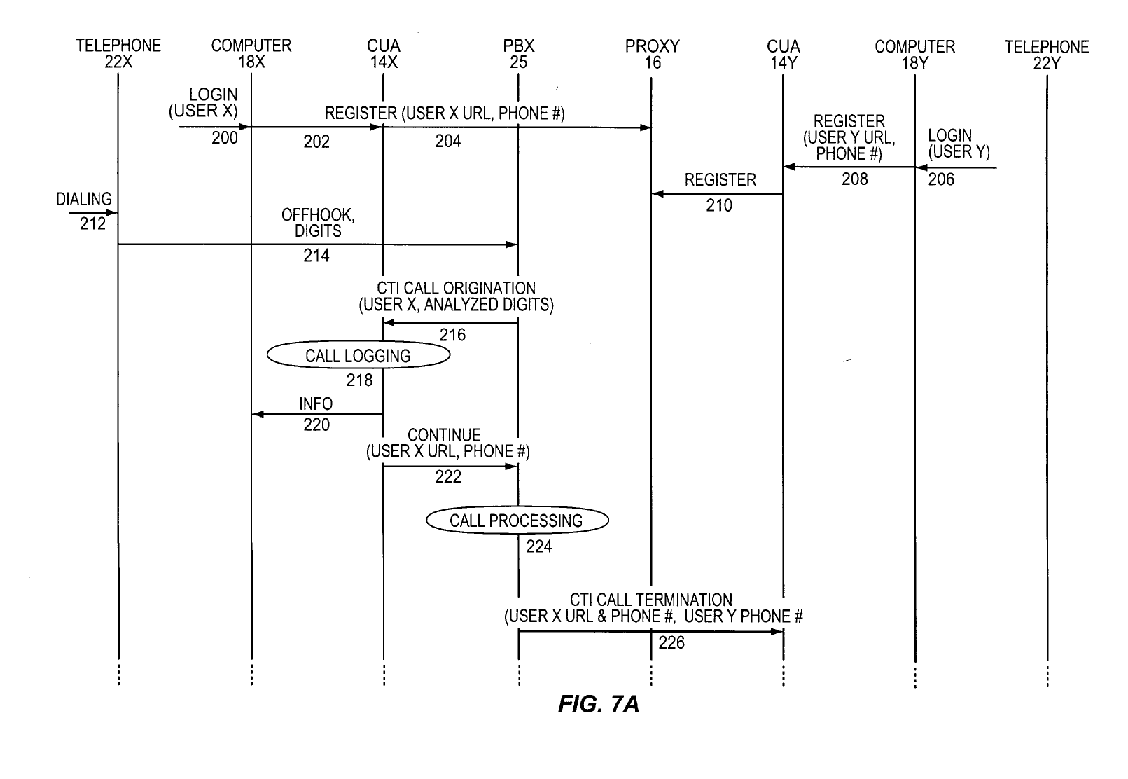

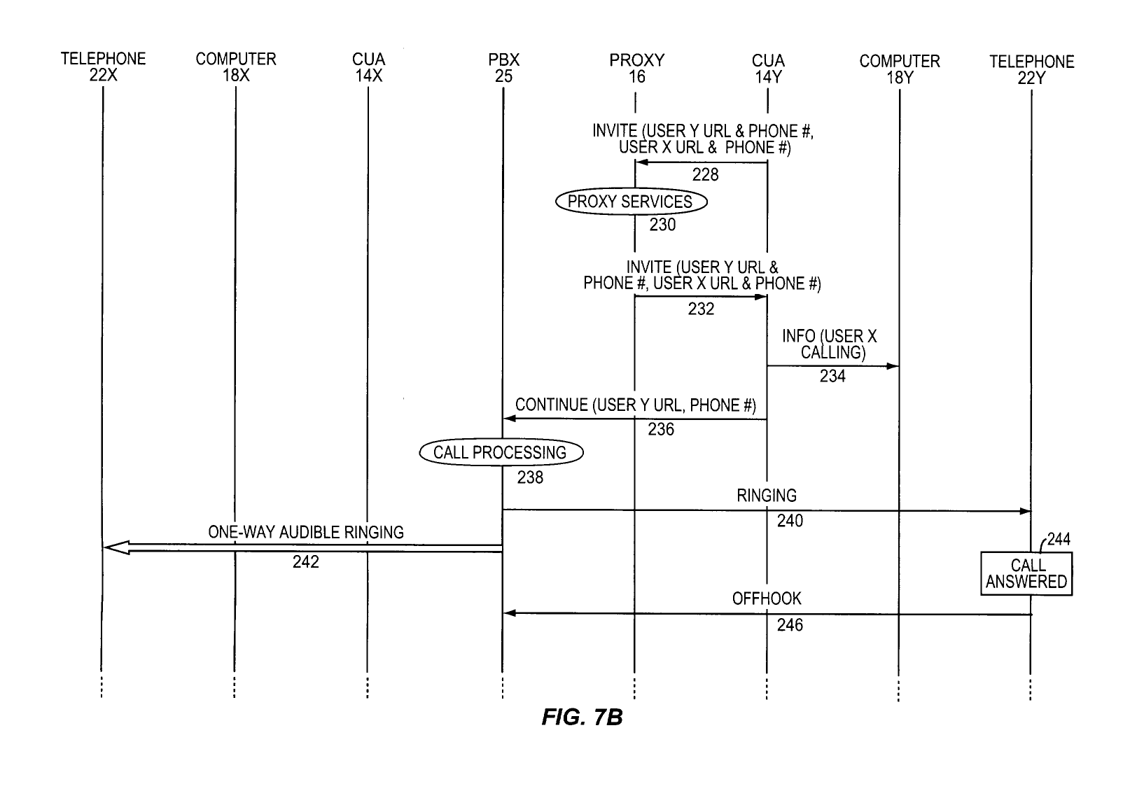

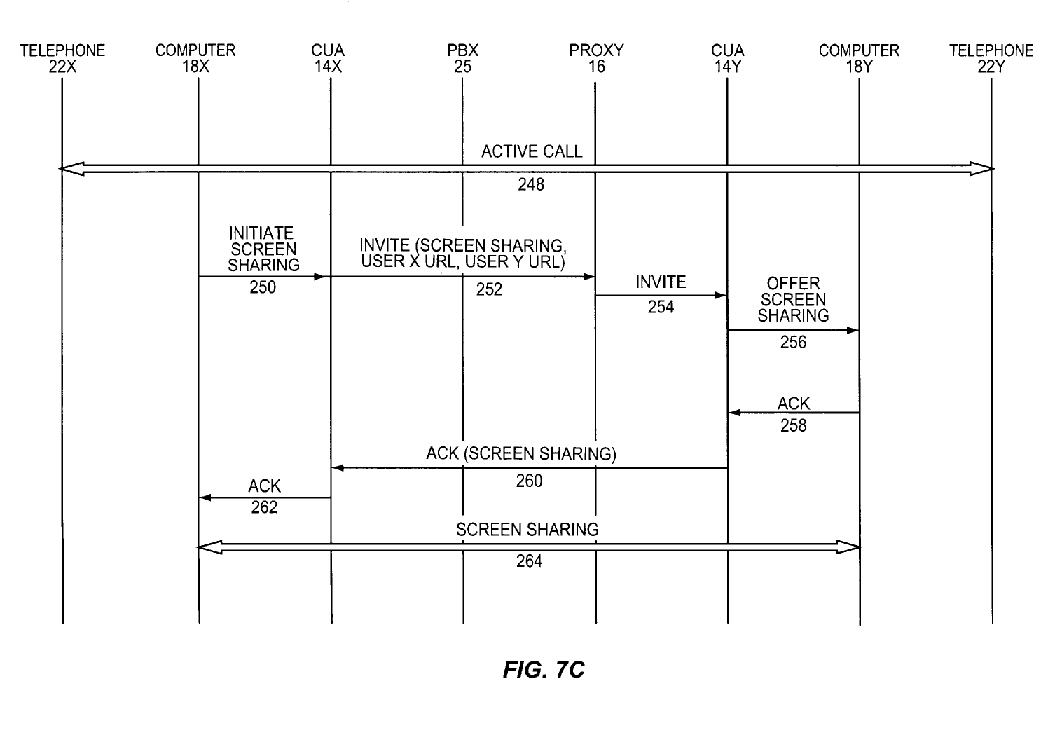

Turning now to FIGS. 7A-7C, an exemplary communication flow is shown for establishing a voice session and a screen sharing session between the telephones 22X and 22Y and the computers 18X and 18Y, respectively, in the communication environment 10 of FIG. 6. In a SIP environment, userX and user Y will log into their respective computers 18X and 18Y, which will register with a common proxy 16. Accordingly, user X will log into computer 18X (step 200), which will send a REGISTER message to CUA 14X with the URL for the computer 1 8X and the telephone number for the associated telephone 22X (step 202). CUA 14X will provide this information to proxy 16 in a REGISTER message (step 204). Likewise, user Y will log into computer 18Y (step 206), which will provide the URL for computer 18Y and the telephone number for associated telephone 22Y to CUA 14Y (step 208), which will send another REGISTER request to proxy 16 (step 210). At this point, combined legacy clients 34X and 34Y are properly registered and ready for initiating voice and other multimedia sessions.

Assume that the session is initiated by user X dialing the telephone number of telephone 22Y (step 212). Accordingly, telephone 22X will alert the PBX 25 of an off-hook status and report the digits dialed (step 214). The PBX 25 will recognize the call attempt and send a CTI call origination message to CUA 14 X identifying user X and providing the reported digits (step 216). CUA 14X will log the call (step 218) and send an INFO message to computer 18X indicating that the call is proceeding (step 220). Computer 18X may use this information to retrieve relevant information like appointments, emails, documents, etc. which may be associated with user Y, who is associated with the telephone number of telephone 22Y. CUA 14X will next send a CONTINUE message to the PBX 25 providing the URL and directory number for user X (step 222). Upon receiving the CONTINUE message, the PBX 25 will provide call processing (step 224). The PBX 25 will begin termination of the call and send a CTI call termination message to CUA 14Y identifying the URL and directory number for user X and the directory number for user Y (step 226).

CUA 14Y will perform a lookup using the telephone number for telephone 22Y, add the corresponding URL for computer 18Y, and forward an INVITE message including the URLs and telephone numbers for both user X and user Y to proxy 16 (step 228). Proxy 16 will provide any necessary services (step 230), such as call screening. Assuming that the call can proceed to telephone 22Y, proxy 16 will respond with an INVITE message back to CUA 14Y (step 232), which will trigger CUA 14Y to send an INFO message indicating that user X is calling user Y on telephone 22Y to computer 18Y for reference (step 234). Further, CUA 14Y will send a CONTINUE message identifying the URL and telephone number for user Y to the PBX 25 (step 236). The PBX 25 will provide further call processing (step 238) and trigger ringing of telephone 22Y (step 240). The PBX 25 will enable the voice path for telephone 22X of user X, which will result in a one-way voice path, with audible ringing to be heard at telephone 22X (step 242).

At some point, user Y will answer their call (step 244), which will prompt the telephone 22Y to indicate an OFFHOOK condition, which is detected by the PBX 25 (step 246). At this point, a call is established between telephone 22X and telephone 22Y (step 248).

Once the voice session is established between telephones 22X and 22Y, a screen sharing application is initiated by user X at computer 18X. Accordingly, computer 18X will send a message to CUA 14X indicating that it wants to initiate screen sharing (step 250). CUA 14X will send a SIP INVITE message having the URLs associated with both users to the supporting proxy 16 indicating that a screen sharing session is desired between computers 18X and 18Y (step 252). The proxy 16 will return the INVITE message to CUA 14Y (step 254). CUA 14Y will send a message offering screen sharing to computer 18Y (step 256). Computer 18Y, assuming that screen sharing is accepted, will send an acknowledgement (ACK) of the screen sharing to CUA 14Y (step 258), which will forward a similar ACK message to CUA 14X (step 260). CUA 14X will then send an ACK message to computer 18X to complete the invitation for screen sharing. (step 262). Upon completion of the ACK messages, a screen sharing session is established between computer 18X and computer 18Y (step 264).

Although screen sharing sessions are illustrated, those skilled in the art will recognize that the concepts of the present invention are equally applicable to video conferencing, audio streaming, video streaming, information streaming, voicemail, email, gaming, advertising, instant messaging, or any other desired multimedia session that may benefit by having an affiliated voice session. Further, although circuit-switched telephones are disclosed and described, the PBX 25 and telephony switch 24 may support devices that further support packet-switched telephones. The invention is equally applicable and beneficial to such configurations, where a voice session or like media session must be carried out at least in part through a telephony switching device. In operation, the CUA 14 is preferably configured to interact with the computer 18 to enhance the functionality and usefulness of applications supporting the voice and multimedia sessions. For example, the CUA 14 can provide information to applications on the computer 18 indicating that a voice session is in progress, and also provide information about the voice session, such as with whom the voice session is occurring and any associated information, such as a telephone number of a participating device or user. These features are particularly useful for remote collaboration, where presentations must be shared easily.

Further detail may be found in commonly assigned application Ser. No. 10/028,510, filed Dec. 20, 2001, which is incorporated herein by reference in its entirety.

Those skilled in the art will recognize improvements and modifications to the preferred embodiments of the present invention. For example, the PBX 25 or switch 24 may be implemented using packet technology instead of TDM, where the voice connection for the voice session may be established over a packet connection. All such improvements and modifications are considered within the scope of the concepts disclosed herein and the claims that follow.

What is claimed is:

1. A system comprising:
a) at least one interface adapted to facilitate media communications; and
b) a control system associated with the at least one interface and providing a combined user agent, which is adapted to:
i) represent a telephony device supported by a PBX and a computing device as a single multimedia device capable of supporting voice and media sessions;
ii) communicate with a telephony switch to establish a connection with the telephony device through the telephony switch and the PBX to facilitate a voice session with another voice-capable device; and
iii) communicate with the computing device to establish a media session between the computing device and another media-capable device,
wherein the combined user agent appears to network devices as a multimedia client supporting voice and media sessions and interacts with the telephony switch as well as the computing device to facilitate the voice and media sessions.

2. The system of claim 1 wherein the at least one interface includes a first interface for communicating with the telephony switch.

3. The system of claim 2 wherein the at least one interface includes a second interface for communicating with the PBX.

4. The system of claim 1 wherein the combined user agent is further adapted to associate the connection and media session with one another.

5. The system of claim 1 wherein the combined user agent is further adapted to provide information associated with the connection to the computing device for use in an application associated with the media session.

6. The system of claim 1 wherein the combined user agent is further adapted to communicate with the telephony switch using call signaling messages required to establish and control the connection between the telephony device and the voice-capable device.

7. The system of claim 6 wherein the combined user agent is further adapted to communicate with the telephony switch using a first protocol.

8. The system of claim 7 wherein the combined user agent is further adapted to communicate with the computing device with signaling messages required to establish and control a media session between the computing device and the media-capable device using a second protocol.

9. The system of claim 1 wherein the combined user agent is further adapted to use the session initiation protocol, SIP, when representing the computing device to other SIP devices.

10. The system of claim 9 wherein the combined user agent is further adapted to use the session initiation protocol when communicating with the computing device to establish the media session between the computing device and another media-capable device.

11. The system of claim 1 wherein the media session established between the computing device and another media-capable device is at least one of the group consisting of video session, screen sharing session, audio streaming, video streaming, information streaming, voicemail, email, gaming, advertising, and instant messaging session.

12. A method facilitating voice and media sessions comprising:
a) representing a telephony device supported by a PBX and a computing device as a combined user agent capable of supporting voice and media sessions;
b) communicating with a telephony switch to establish a connection with the telephony device through the telephony switch and the PBX to facilitate a voice session with another voice-capable device; and
c) communicating with a computing device to establish a media session between the computing device and another media-capable device,
wherein the combined user agent appears to network devices as a multimedia client supporting voice and media sessions and interacts with the telephony switch as well as the computing device to facilitate the voice and media sessions.

13. The method of claim 12 further comprising communicating directly with the telephony switch.

14. The method of claim 13 further comprising communicating directly with the PBX.

15. The method of claim 12 further comprising associating the connection and media session with one another.

16. The method of claim 12 further comprising providing information associated with the connection to the computing device for use in an application associated with the media session.

17. The method of claim 12 further comprising communicating with the telephony switch using call signaling messages required to establish and control the connection between the telephony device and the voice-capable device.

18. The method of claim 17 further comprising communicating with the telephony switch using a first protocol.

19. The method of claim 18 further comprising communicating with the computing device with signaling messages required to establish and control a media session between the computing device and the media-capable device using a second protocol.

20. The method of claim 12 further comprising communicating using the session initiation protocol, SIP, when representing the computing device to other SIP devices.

21. The method of claim 20 further comprising communicating using the session initiation protocol when communicating with the computing device to establish the media session between the computing device and another media-capable device.

22. The method of claim 12 wherein the media session established between the computing device and another media-capable device is at least one of the group consisting of video session, screen sharing session, audio streaming, video streaming, information streaming, voicemail, email, gaming, advertising, and instant messaging session.

23. A system comprising:
a) an interface adapted to facilitate media communications; and
b) a control system associated with the interface and providing a combined user agent, which is adapted to:
i) represent a first telephony device supported by a PBX and a computing device as a single multimedia device capable of supporting voice and media sessions;
ii) communicate with the PBX to identify establishment of a connection between the first telephony device and a second telephony device supported by the PBX through the PBX to facilitate a voice session; and
iii) communicate with the computing device to establish a media session between the computing device and another media-capable device,
wherein the combined user agent appears to network devices as a multimedia client supporting voice and media sessions and interacts with the PBX as well as the computing device to facilitate and media sessions and associated voice sessions between the first and second telephony devices.

24. The system of claim 23 wherein the combined user agent is further adapted to associate the connection and media session with one another.

25. The system of claim 23 wherein the combined user agent is further adapted to provide information associated with the connection to the computing device for use in an application associated with the media session.

26. The system of claim 23 wherein the combined user agent is further adapted to use the session initiation protocol, SIP, when representing the multimedia device to other SIP devices.

27. The system of claim 26 wherein the combined user agent is further adapted to use the session initiation protocol when communicating with the computing device to establish the media session between the computing device and another media-capable device.

28. The system of claim 23 wherein the media session established between the computing device and another media-capable device is at least one of the group consisting of video session, screen sharing session, audio streaming, video streaming, information streaming, voicemail, email, gaming, advertising, and instant messaging session.

29. A method facilitating voice and media sessions comprising:
a) representing a first telephony device supported by a PBX and a computing device as a single multimedia device capable of supporting voice and media sessions;
b) communicating with the PBX to identify establishment of a connection between the first telephony device and a second telephony device supported by the PBX through the PBX to facilitate a voice session; and
c) communicating with the computing device to establish a media session between the computing device and another media-capable device,
wherein the combined user agent appears to network devices as a multimedia client supporting voice and media sessions and interacts with the PBX as well as the computing device to facilitate and media sessions and associated voice sessions between the first and second telephony devices.

30. The method of claim 29 further comprising associating the connection and media session with one another.

31. The method of claim 29 further comprising providing information associated with the connection to the computing device for use in an application associated with the media session.

32. The method of claim 29 further comprising communicating using the session initiation protocol, SIP, when representing the multimedia device to other SIP devices.

33. The method of claim 32 further comprising communicating using the session initiation protocol when communicating with the computing device to establish the media session between the computing device and another media-capable device.

34. The method of claim 29 wherein the media session established between the computing device and another media-capable device is at least one of the group consisting of video session, screen sharing session, audio streaming, video streaming, information streaming, voicemail, email, gaming, advertising, and instant messaging session.

35. A private branch exchange comprising:
a) a telephone interface supporting first and second telephony devices of an enterprise;
b) a second interface;
c) a control system associated with the telephone interface and the second interface and adapted to:
i) receive information via the telephone interface from the first telephony device to establish a connection between the first and second telephony devices; and
ii) send a first message to a first combined user agent associated with the first telephony device regarding the connection wherein the first combined user agent is adapted to facilitate a media session between first and second media devices associated with the first and second telephony devices, respectively.

36. The private branch exchange of claim 35 wherein the control system is further adapted to send a second message to a second combined user agent associated with the second telephony device regarding the connection to further facilitate the media session between the first and second media devices associated with the first and second telephony devices.

37. The private branch exchange of claim 35 wherein the information received via the telephone interface from the first telephony device comprises a telephone number according to an enterprise dialing plan for the second telephony device.

38. The private branch exchange of claim 35 wherein the control system is further adapted to establish a circuit-switched connection between the first and second telephony devices.
